(19) United States
(12) Patent Application Publication
(10) Pub. No.: US 2024/0056334 A1
(43) Pub. Date: Feb. 15, 2024

(54) METHODS AND APPARATUS FOR DIGITAL DATA COMMUNICATION WITH BUS POWER OVER INTERCONNECTS

(71) Applicant: Analog Devices, Inc., Wilmington, MA (US)

(72) Inventors: Eric CLINE, Lowell, MA (US); Martin KESSLER, Salem, MA (US)

(21) Appl. No.: 17/885,339

(22) Filed: Aug. 10, 2022

(51) Int. Cl. H04L 12/40; G06F 1/28

(52) U.S. Cl. CPC H04L 12/40045; H04L 12/40032; G06F 1/28

(57) ABSTRACT

Aspects of the present disclosure include methods and systems for transmitting digital information including generating digital information, converting the digital information to two or more transmission signals, outputting each of the two or more transmission signals onto a respective wire of two wires of a cable for at least a first slave node, and outputting a supply current via the two wires for at least the first slave node.

### BACKGROUND

The present disclosure relates generally to communication systems and, more particularly, to two-wire communication systems and applications.

### BACKGROUND

In many applications, such as automotive or music/audio recording/playback, multiple devices may communicate via cables. In addition to exchanging digital and/or analog signals that carry data, the cables may be also be used to supply electrical energy to the devices. Each cable may include input and/or output terminals or pins. Certain terminals/pins may be allocated for data communication, while others may be allocated for delivering electrical energy. Improvements to digital data communication may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include a circuit for digital communication, comprising: a cable having two wires and a shielding layer, wherein the shielding layer is connected to a common voltage terminal, a master node configured to: generate digital information, convert the digital information to two or more transmission signals, and output each of the two or more transmission signals onto a respective wire of the two wires, a power source configured to output a supply current via the two wires, and a first slave node configured to: receive the supply current from the two wires for providing electrical energy to the first slave node, receive the two or more transmission signals via the two wires, and convert the two or more transmission signals to the digital information.

Aspects of the present disclosure include a master node device, comprising: a cable having two wires and a shielding layer, wherein the shielding layer is connected to a common voltage terminal, a master node comprising: a memory, a processor communicatively coupled to the memory and a communication circuit, the processor being configured to: generate digital information, transmit the digital information to the communication circuit, and the communication circuit configured to: convert the digital information to two or more transmission signals, and output each of the two or more transmission signals onto a respective wire of the two wires, and a power source configured to output a supply current via the two wires.

Aspects of the present disclosure include a slave node device, comprising: a cable having two wires and a shielding layer, wherein the shielding layer is connected to a common voltage terminal, and a slave node comprising: a memory, a communication circuit configured to: receive two or more transmission signals via the two wires of the cable, convert the two or more transmission signals to digital information, transmit the digital information to a processor, and the processor communicatively coupled to the memory and the communication circuit, the processor being configured to: cause the slave node device to receive a supply current from the two wires for providing electrical energy to the slave node device, and receive the digital information.

Aspects of the present disclosure include methods and systems for transmitting digital information including generating digital information, converting the digital information to two or more transmission signals, outputting each of the two or more transmission signals onto a respective wire of two wires of a cable for at least a first slave node, and outputting a supply current via the two wires for at least the first slave node.

Aspects of the present disclosure include methods and systems for receiving digital information including receiving a supply current from two wires of a cable for providing electrical energy to the slave node device, receiving two or more transmission signals via the two wires, and converting the two or more transmission signals to digital information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a circuit diagram according to aspects of the present disclosure.

FIG. 2 illustrates examples of signals transmitted by the master node according to aspects of the present disclosure.

FIG. 3 illustrates examples of signals received by the slave nodes according to aspects of the present disclosure.

FIG. 4 illustrates an example of processing signals according to aspects of the present disclosure.

FIG. 5 illustrates an example of converting processed signals to digital information according to aspects of the present disclosure.

FIG. 6 illustrates examples of hardware diagrams of the master and slave nodes according to aspects of the present disclosure.

FIG. 7 illustrates an example of a method for transmitting digital information according to aspects of the present disclosure.

FIG. 8 illustrates an example of a method for receiving digital information according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication devices will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In one aspect of the present disclosure, a circuit for digital communication may include a master node connected to one or more slave nodes via a cable. The master node may transmit digital information via two or more wires in the cable to the one or more slave nodes. Further, the master node may receive digital information via the two or more wires in the cable from the one or more slave nodes. In one aspect of the present disclosure, the two or more wires may be connected to (via an optional switch and/or low pass filters) a high voltage terminal (i.e., “hot”) of a power source (e.g., voltage supply or a current supply). The power source may supply electrical energy to the master node and the one or more slave nodes via the two or more wires of the cable. A shielding layer of the cable may be grounded and/or connected to a common voltage terminal (i.e., “neutral”) of the power source.

Aspects of the present disclosure may allow the master node and/or the power source to provide more electrical energy to the one or more slave nodes without additional wires and/or connections.

In some aspects of the present disclosure, the master node may provide synchronization signals to the one or more slave nodes. The synchronization signals may act as “heart beat” signals to synchronization timings of the master node and the one or more slave nodes.

In certain aspects, one or more of the slave nodes that draw more electrical power may be placed electrically closer (less loads between the master node and the slave node) to the master node. In other aspects slave nodes of the one or more slave nodes that draw more electrical power may be placed electrically farther from the master node (more loads between the master node and the slave node). In yet another aspect, slave nodes that draw more electrical power may be interspersed among the one or more slave nodes.

In one implementation, for example, instead of one of the differential wires in the wire pair being biased high for bus power and the other wire being biased low for the return current to ground, both differential wires are biased high while the shield and/or a separate ground wire act as the return current to ground while the same wire pair is also used for digital communication.

In some aspects, cables with XLR connectors may be used in professional audio such as in studios and concert stages. For example, the cables with XLR connectors may be used for balanced analog audio channel (mono) per cable and/or unbalanced analog audio channels (stereo) or for microphone connectivity with weak phantom power. One existing digital interface technology using XLR connectors is AES/EBU, which may support two audio channels. However, the AES/EBU technology does not use direct current (DC) bias and therefore provides no bus power. Many audio connectivity in studios and stages is analog and therefore susceptible to noise and interference. However, there is a need for audio equipment that implement digital, DSP based architectures, driving the need for high density interconnects.

Aspect of the present disclosure include the use of XLR interconnects for digital high density interconnect (>32 audio channels, bidirectional) that includes power supply over the same cable. Each wire of the differential pair is biased high with an inductor based low pass filter and the shield is also the return current to ground. The same wire pair is also used for digital communication with a capacitive or transformer coupled high pass filter. A charge-pump controlled n-type field effect transistor (NFET) may switch bus power in a controlled, slow ramp manner to prevent excessive current draw during charging of bus powered node capacitors.

Line Current Protection may be applied by sensing a series resistor to prevent overcurrent situations in case of connector mishandling. Line Diagnostics coupled to the sense resistor and NFET switch may determine if there is an open circuit or short circuit.

Instead of one of the differential wires in the wire pair being biased high for bus power and the other wire being biased low for the return current to ground, both differential wires are biased high while the shield and/or a separate ground wire act as the return current to ground while the same wire pair is also used for digital communication. In some instances, the shield may be shorted to the ground wire.

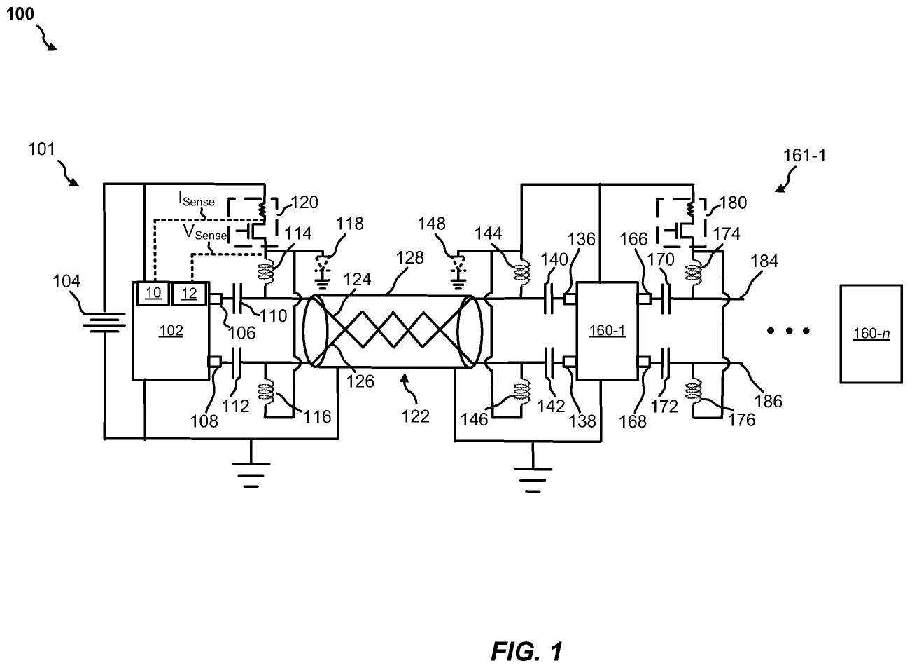

FIG. 1 illustrates an example of a circuit 100 for digital data communications. The circuit 100 may include a master node device 101 and one or more slave node devices, such as a first slave node device 161-1. In certain aspects of the present disclosure, the circuit 100 may include a master node 102 and one or more slave nodes 160-1 . . . 160-n where n is a positive integer. In some instances, the circuit 100 may include a single slave node (n=1). In other instances, the circuit 100 may include more than one slave nodes (n>1). The circuit 100 may include a power source 104 configured to provide electrical energy to various components of the circuit 100 (as described below). The power source 104 may be a current source or a voltage source. The power source 104 may be connected to and supply electrical energy to the master node 102.

In some instances, the master node 102 may include the IC chip in the master node device 101. The master node device 101 may include peripheral components such as low pass filters, high pass filters, connectors, switches, or other devices as described below. The slave node 160-1 may include the IC chip in the slave node device 161-1. The slave node device 161-1 may include peripheral components such as low pass filters, high pass filters, connectors, switches, or other devices as described below.

In some aspects, the master node 102 may be configured to communicate digital information with the one or more slave nodes 160-1 . . . 160-n via a cable 122. The cable 122 may include first wires 124, 126 configured to carry digital information. The cable 122 may be an XLR cable, a Musical Instrument Digital Interface (MIDI) cable, or other suitable cables. In some examples, the cable 122 may include one or more cables and/or one or more connectors. For example, the cable 122 may include a female connector on the master node 102 and a male connector on the first slave node 160-1. Other configurations may also be implemented according to aspects of the present disclosure.

In some instances, the master node 102 may transmit digital information to each of the one or more slave nodes 160-1 . . . 160-n. In other instances, the master node 102 may be configured to transmit digital information to a subset of the one or more slave nodes 160-1 . . . 160-n. Similarly, the master node 102 may be configured to receive digital information from each of the one or more slave nodes 160-1 . . . 160-n. In other instances, the master node 102 may be configured to receive digital information from a subset of the one or more slave nodes 160-1 . . . 160-n. The information transmitted to and/or received from the one or more slave nodes 160-1 . . . 160-n may be the same or different for each of the one or more slave nodes 160-1 . . . 160-n.

In an aspect of the present disclosure, the master node 102 may include first terminals 106, 108 configured to transmit and/or receive digital information signals, such as differential signals, generated by the master node 102. The circuit 100 may include first high pass filters 110, 112 configured to suppress, reduce, or eliminate at least some signals below a certain threshold frequency (e.g., filtering out direct current (DC) signals). Examples of the first high pass filters 110, 112 may include one or more of capacitors, resistors, and/or inductors. The first high pass filters 110, 112 may be connected to the first wires 124, 126 of the cable 122. The first terminals 106, 108 may be connected to the first high pass filters 110, 112, respectively. The digital information signals transmitted by the master node 102 via the first terminals 106, 108 may be filtered by the first high pass filters 110, 112. The digital information signals filtered by the first high pass filters 110, 112 may be transmitted to the one or more slave nodes 160-1 . . . 160-n via the first wires 124, 126 of the cable 122.

In some aspects of the present disclosure, the first wires 124, 126 of the cable 122 may be shielded or unshielded twisted pair wires. The cable 122 may include a shielding layer 128 configured to reduce an amount of electromagnetic interference to the first wires 124, 126 caused by one or more external sources (not shown). The shielding layer 128 may include a cylindrical sheet of metal that encases the first wires 124, 126.

In certain aspects, the circuit 100 may include a first optional switch 120 configured to control the electrical energy supplied to the one or more slave nodes 160-1 . . . 160-n. Examples of the first optional switch 120 may include transistors (e.g., one or more of a metal-oxide-semiconductor field effect transistor (MOSFET), metal-semiconductor field effect transistor (MESFET), bipolar junction transistor (BJT), junction field effect transistor (JFET), etc.), diodes, and/or other active or passive devices (e.g., resistors). The power source 104 may be connected to the first optional switch 120. The master node 102 may be configured to open or close the first optional switch 120 based on instructions requiring the master node 102 to control the one or more slave nodes 160-1 . . . 160-n.

In some aspects of the present disclosure, the circuit 100 may include first low pass filters 114, 116 configured to suppress, reduce, or eliminate at least some signals above a certain threshold frequency (e.g., filtering out alternative current (AC) signals). Examples of the first low pass filters 114, 116 may include one or more of inductors, resistors, and/or capacitors. The first optional switch 120 may be connected to the first low pass filters 114, 116. The first low pass filters 114, 116 may be connected to the first wires 124, 126 of the cable 122. Electrical energy provided by the power source 104 may be filtered by the first low pass filters 114, 116 (when the first optional switch 120 is closed). The electrical energy filtered by the first low pass filters 114, 116 may be provided to the one or more slave nodes 160-1 . . . 160-n via the first wires 124, 126 of the cable 122.

In certain aspects, the circuit 100 may include a first optional light emitting diode (LED) 118 configured to emit light in response to the first optional switch 120 being in the closed position. The first optional LED 118 may indicate that electrical energy is being provided to at least one of the one or more slave nodes 160-1 . . . 160-n (e.g., the first slave node 160-1 immediately connected to the master node 102).

In some aspects, the circuit 100 may include a second optional LED 148 configured to emit light if electrical energy is being received at the first slave node 160-1.

In some aspects, the master node 102 optionally include a current sensing circuit 10. The current sensing circuit 10 in the master node 102 may detect the voltage drop across the resistor of the first optional switch 120 to determine the current flowing through the first optional switch 120. The current sensing circuit 10 may utilize a first probe I_{Sense} to detect the voltage drop across the resistor of the first optional switch 120.

In some aspects, the master node 102 optionally include a voltage sensing circuit 12. The voltage sensing circuit 12 in the master node 102 may detect the voltage between the first optional switch 120 and the first low pass filters 114, 116 to determine voltage on the on the bus (i.e., the cable 122). The voltage sensing circuit 12 may rely on a second probe Vₛₑₙₛₑ to detect the voltage on the bus.

In some instances, the master node 102 may utilize the information measured by the current sensing circuit 10 and/or the voltage sensing circuit 12 (e.g., current and/or voltage levels) to adjust the output level of the power source 104. For example, if the master node 102 detects an under current via the current sensing circuit 10, the master node 102 may increase the current output level of the power source 104.

In certain aspects of the present disclosure, the one or more slave nodes 160-1 . . . 160-n may optionally include a voltage sensing circuit and/or a current sensing circuit (not shown).

In some aspects, the circuit 100 may include second low pass filters 144, 146 configured to suppress, reduce, or eliminate at least some signals above a certain threshold frequency (e.g., filtering out AC signals). Examples of the second low pass filters 144, 146 may include one or more of inductors, resistors, and/or capacitors. The second low pass filters 144, 146 may be connected to the first wires 124, 126 at a first end and at least the first slave node 160-1 of the one or more slave nodes 160-1 . . . 160-n at a second end. The first wires 124, 126 may be configured to carry both the filtered digital information and the filtered electrical energy. The second low pass filters 144, 146 may be configured to filter at least a portion of the AC signals (e.g., filtering out the filtered digital information) and/or to provide at least a portion of the filtered electrical energy to at least the first slave node 160-1 of the one or more slave nodes 160-1 . . . 160-n.

In certain aspects of the present disclosure, the first slave node 160-1 of the one or more slave nodes 160-1 . . . 160-n may include second terminals 136, 138 configured to receive and/or transmit digital information signals, such as differential signals.

In some aspects, the circuit 100 may include second high pass filters 140, 142 configured to suppress, reduce, or eliminate at least some signals below a certain threshold frequency (e.g., filtering out DC signals). Examples of the second high pass filters 140, 142 may include one or more of capacitors, resistors, and/or inductors. The first slave node 160-1 may include second terminals 136, 138. The second high pass filters 140, 142 may be connected to the first wires 124, 126 of the cable 122 at a first end and the second terminals 136, 138 at a second end. The second high pass filters 140 may be configured to filter at least a portion of the DC signals (e.g., filtering out the filtered electrical energy) and/or to provide the filtered digital information to the second terminals 136, 138 of the first slave node 160-1.

In some aspects of the present disclosure, the first slave node 160-1 may optionally include third terminals 166, 168 configured to transmit and/or receive digital information signals, such as differential signals, generated by the first slave node 160-1. The circuit 100 may optionally include third high pass filters 170, 172 configured to suppress, reduce, or eliminate at least some signals below a certain threshold frequency (e.g., filtering out direct current (DC) signals). Examples of the third high pass filters 170, 172 may include one or more of capacitors, resistors, and/or inductors. The third high pass filters 170, 172 may be connected to the second wires 184, 186 of a next cable (if any, not shown in FIG. 1). The third terminals 166, 168 may be connected to the third high pass filters 170, 172, respectively. The digital information signals transmitted by the first slave node 160-1 via the third terminals 166, 168 may be filtered by the third high pass filters 170, 172. The digital information signals filtered by the third high pass filters 170, 172 may be transmitted to a next slave node (if any) the one or more slave nodes 160-1 . . . 160-n via the second wires 184, 186 of the next cable.

In some aspects of the present disclosure, the circuit 100 may optionally include third low pass filters 174, 176 configured to suppress, reduce, or eliminate at least some signals above a certain threshold frequency (e.g., filtering out AC signals). Examples of the third low pass filters 174, 176 may include one or more of inductors, resistors, and/or capacitors. The circuit 100 may include a second optional switch 180. The second optional switch 180 may be connected to the third low pass filters 174, 176. The third low pass filters 174, 176 may be connected to the second wires 184, 186 of the next cable. Electrical energy provided by the power source 104, and provided through the cable 122, may be filtered by the third low pass filters 174, 176 (when the second optional switch 180 is closed). The electrical energy filtered by the third low pass filters 174, 176 may be provided to the next slave node (if any) the one or more slave nodes 160-1 . . . 160-n. The first slave node 160-1 may control the second optional switch 180.

In some aspects of the present disclosure, the circuit 100 may include the master node 102 and only a single slave node (i.e., the first slave node 160-1). In other aspects, the circuit 100 may include the master node 102 and more than one of the one or more slave nodes 160-1 . . . 160-n. The circuit components associated with the remaining slave nodes may be similar to the circuit components associated with the first slave node 160-1.

In some aspects, the one or more slave nodes 160-1 . . . 160-n may be used to control automotive devices (e.g., turn signals, windshield wipers . . . ), audio devices (e.g., speakers, microphones, stage lightings . . . ), video devices (e.g., cameras, displays . . . ), or other electronic devices.

In certain aspects of the present disclosure, digital information may be communicated among the master node 102 and the one or more slave nodes 160-1 . . . 160-n synchronously or asynchronously. For example, the master node 102 may transmit “downstream” digital information to the one or more slave nodes 160-1 . . . 160-n during a first time period allocated for downstream transmission. The one or more slave nodes 160-1 . . . 160-n may transmit “upstream” digital information to the master node 102 (or other slave nodes) during a second period allocated for upstream transmission. Alternatively, the master node 102 and the one or more slave nodes 160-1 . . . 160-n may utilize other schemes for utilizing the bus for communication (e.g., weighted round robin, fair queuing, first-in-first-out, etc.).

In some aspects, some or all of the one or more slave nodes 160-1 . . . 160-n may be powered by local sources (e.g., batteries). In these implementations, the one or more slave nodes 160-1 . . . 160-n may be enabled and/or disabled by sensing the bias on the bus lines (e.g., the first wires 124, 126) via sensors (e.g., opto-coupler for galvanic isolation). For example, if one slave node of the one or more slave nodes 160-1 . . . 160-n senses a bias on the bus lines, the slave node may activate input detectors to detect incoming signals.

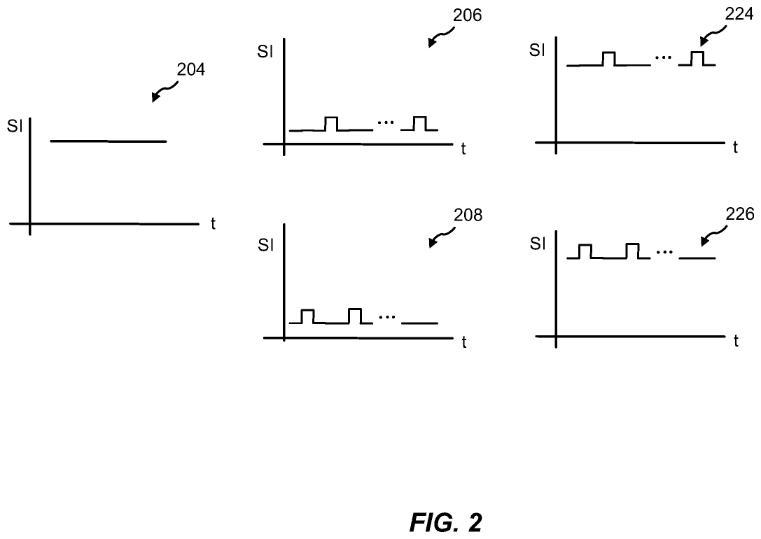

FIG. 2 illustrates examples of signals communicated between the master node 102 and/or the one or more slave nodes 160-1 . . . 160-n (FIG. 1). The abscissa axes may show time and the ordinate axes may show signal intensity, such as voltage, current, power, or other relevant units.

Referring to FIGS. 1 and 2, during normal operations of the circuit 100, the power source 104 may supply a supply current 204 to the master node 102 and/or the one or more slave nodes 160-1 . . . 160-n for use as electrical energy. The master node 102 may output a first transmission signal 206 and a second transmission signal 208 via the first terminals 106, 108, respectively. The first transmission signal 206 and the second transmission signal 208 may be digital signals.

In some aspects of the present disclosure, the first optional switch 120 may close to allow the supply current 204 through. The first low pass filters 114, 116 may filter some or all AC components in the supply current 204. The filtered supply current 204 may be provided to the first wires 124, 126.

In certain aspects, the first high pass filters 110, 112 may filter the first transmission signal 206 and the second transmission signal 208, respectively. The first high pass filters 110, 112 may filter some or all DC components in the first transmission signal 206 and the second transmission signal 208. The first transmission signal 206 and the second transmission signal 208 (after filtering) may be provided to the first wires 124, 126.

In some aspects, after the filtering by the first high pass filters 110, 112 and the first low pass filters 114, 116, the filtered signals may combine to form a first total signal 224 based on the filtered supply current 204 and the first transmission signal 206, and a second total signal 226 based on the filtered supply current 204 and the second transmission signal 208. In some cases, the first total signal 224 and the second total signal 226 may each include AC and DC components. The first total signal 224 and/or the second total signal 226 may be transmitted via the first wires 124, 126 of the cable to the one or more slave nodes 160-1 . . . 160-n.

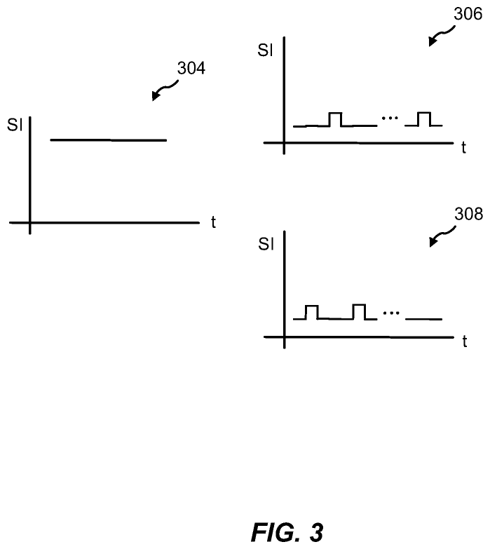

Referring to FIGS. 1-3, in one aspect of the present disclosure, the second low pass filters 144, 146 may filter the first total signal 224 and the second total signal 226 received via the first wires 124, 126, respectively. The second low pass filters 144, 146 may filter some or all AC components in the first total signal 224 and the second total signal 226 to generate a received supply current 304. The received supply current 304 may be provided to the first slave node 160-1 as electrical energy.

In some aspects of the present disclosure, the second high pass filters 140, 142 may filter the first total signal 224 and the second total signal 226 received via the first wires 124, 126, respectively. The second high pass filters 140, 142 may filter some or all DC components in the first total signal 224 and the second total signal 226 to generate a first received signal 306 and a second received signal 308, respectively. The first received signal 306 and the second received signal 308 may be provided to the first slave node 160-1 via the second terminals 136, 138, respectively. The first slave node 160-1 may process the digital data carried by the first received signal 306 and the second received signal 308 as described below.

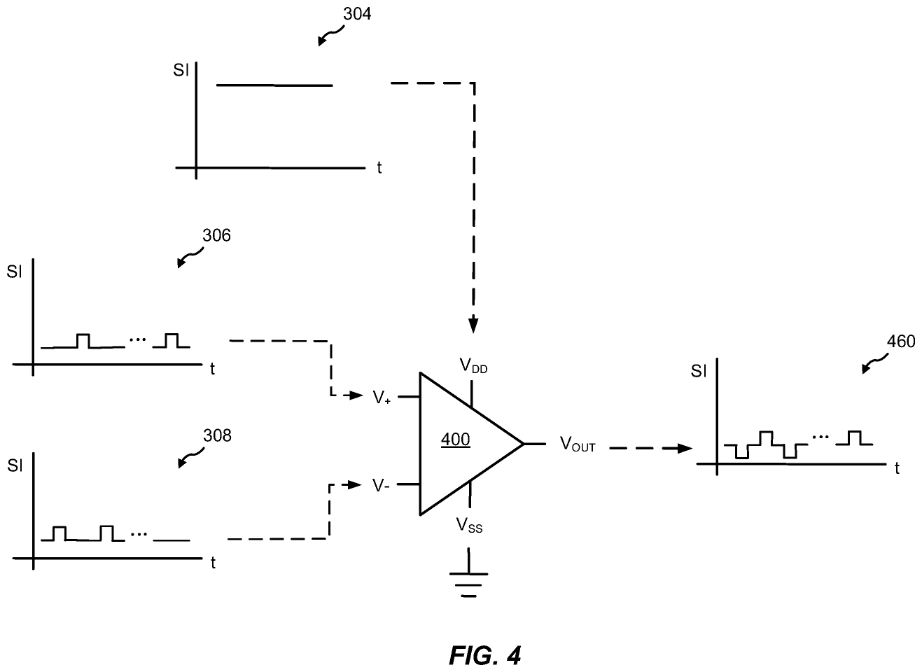

Turning to FIG. 4, and also referencing FIG. 1, the first slave node 160-1 may convert the first received signal 306 and the second received signal 308 into a first differential signal 460. The first slave node 160-1 may include a differential amplifier 400 configured to convert the first received signal 306 and the second received signal 308 into the first differential signal 460 based on the following equation:

V_{OUT}=A(V₊−V₋).

Here, “A” is the gain of the differential amplifier 400, V_{OUT} is the output voltage, and V₊ and V₋ are the input voltages. The first differential signal 460 may carry digital information for the first slave node 160-1, and or other slave nodes (if any) of the one or more slave nodes 160-1 . . . 160-n.

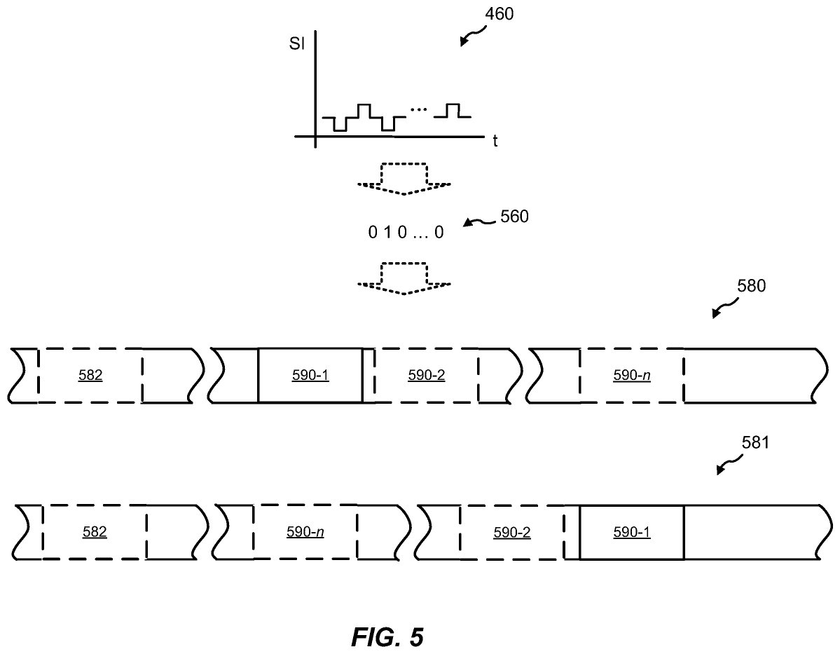

FIG. 5 illustrates an example of digital data carried in the first differential signal 460. In some aspects, the first slave node 160-1 may convert the first received signal 306 and the second received signal 308 into the first differential signal 460. The first slave node 160-1 may convert the first differential signal 460 into first bit data 560. The first slave node 160-1 may convert the first bit data 560 to first digital data 580. In certain examples, the first digital data 580 may include optional control data 582 associated with the first digital data 580. The first digital data 580 may include first slave data 590-1 for the first slave node 160-1. The first digital data 580 may optionally append additional slave data 590-2 . . . 590-n after the first slave data 590-1 for other slave nodes of the one or more slave nodes 160-1 . . . 160-n. When relaying the additional slave data 590-2 . . . 590-n to the other slave nodes, the first slave node 160-1 may relay the first digital data 580, or relay a portion of the first digital data without the first slave data 590-1.

In alternative implementations, the first slave node 160-1 may convert the first bit data 560 to second digital data 581. The second digital data 581 may include similar or substantial similar contents as the first digital data 580. However, the second digital data 581 may include the slave data 590 arranged reciprocally. As such, when relaying data to the other slave nodes of the one or more slave nodes 160-1 . . . 160-n, the first slave node 160-1 may truncate the first slave data 590-1 from the second digital data 581, and transmit the remaining portion of the second digital data 581 to the other slave nodes according methods described above.

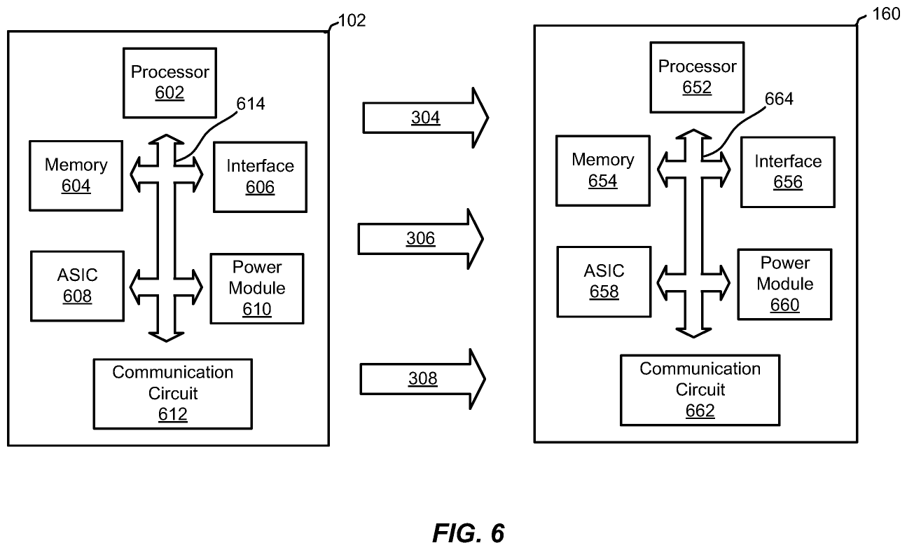

FIG. 6 illustrates examples of hardware of the master node and the slave nodes. Referencing FIGS. 1-6, for example, the master node 102 may include a processor 602 configured to process and/or generate digital information. The master node 102 may include a memory 604 configured to store instructions for execution by the processor 602. The master node 102 may include an interface 606 configured to transmit and/or receive signals, such as the first transmission signal 206 and the second transmission signal 208. The master node 102 may include one or more application specific integrated circuit (ASIC) 608 configured to perform applications associated with the master node 102. For example, the master node 102 may include the ASIC 608 configured to control an automotive device, an audio device, a video device, etc. The master node 102 may include a power module 610 configured to receive the supply current 204 from the power source 104. The power module 610 may be configured supply electrical energy from the supply current 204 to other components of the master node 102. The master node 102 may include a communication circuit 612 configured to convert signals to digital information and vice versa. For example, the communication circuit 612 may be configured to convert digital information into the first transmission signal 206 and the second transmission signal 208. The master node 102 may include an internal bus 614 for exchanging signals, information, and/or electrical energy. In other implementations, the master node 102 may include less device or more devices not shown according to aspects of the present disclosure.

In some aspects, the slave node 160 (any one of the one or more slave nodes 160-1 . . . 160-n) may include a processor 652 configured to process and/or generate digital information. The slave node 160 may include a memory 654 configured to store instructions for execution by the processor 652. The slave node 160 may include an interface 656 configured to transmit and/or receive signals, such as the first received signal 306 and the second received signal 308. The slave node 160 may include one or more application specific integrated circuit (ASIC) 658 configured to perform applications associated with the slave node 160. For example, the slave node 160 may include the ASIC 658 configured to control an automotive device, an audio device, a video device, etc. The slave node 160 may include a power module 660 configured to receive the received supply current 304 from the master node 102. The power module 660 may be configured supply electrical energy from the supply current 204 to other components of the slave node 160. The slave node 160 may include a communication circuit 662 configured to convert signals to digital information and vice versa. For example, the communication circuit 662 may be configured to convert the first received signal 306 and the second received signal 308 to the first differential signal 460 and/or the first bit data 560. The slave node 160 may include an internal bus 664 for exchanging signals, information, and/or electrical energy. In other implementations, the slave node 160 may include less device or more devices not shown according to aspects of the present disclosure.

In one instance, the communication circuit 612, 662 may each include the differential amplifier 400 (FIG. 4) described above.

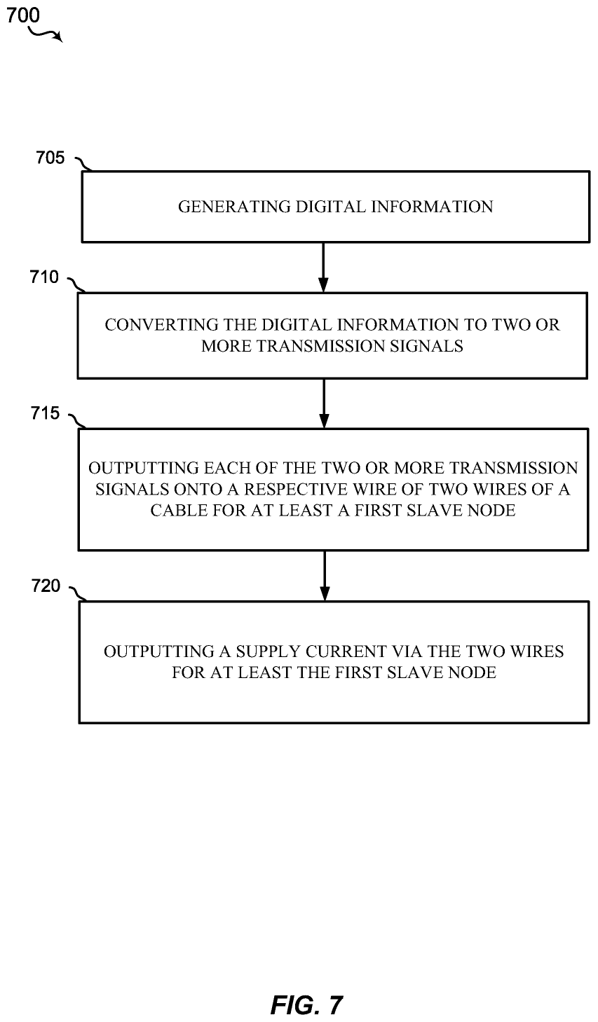

Turning to FIG. 7, an example of a method 700 for transmitting digital information may be performed by the master node device 101, the subcomponents of the master node device 101, the master node 102, and/or the subcomponents of the master node 102.

At block 705, the method 700 may generate digital information. For example, the processor 602 of the master node 102 may generate digital information to be transmitted to the one or more slave nodes 160-1 . . . 160-n. The processor 602 may be configured to and/or define means for generating digital information.

At block 710, the method 700 may convert the digital information to two or more transmission signals. For example, the processor 602 and/or the communication circuit 612 of the master node 102 may convert the digital information to the first transmission signal 206 and the second transmission signal 208. The processor 602 and/or the communication circuit 612 may be configured to and/or define means for converting the digital information to two or more transmission signals.

At block 715, the method 700 may output each of the two or more transmission signals onto a respective wire of two wires of a cable for at least a first slave node. For example, the processor 602, the interface 606, and/or the communication circuit 612 may output each of the first transmission signal 206 and the second transmission signal 208 onto a respective wire of the first wires 124, 126. The processor 602, the interface 606, and/or the communication circuit 612 may be configured to and/or define means for outputting each of the two or more transmission signals onto a respective wire of two wires of a cable for at least a first slave node.

At block 720, the method 700 may output a supply current via the two wires for at least the first slave node. For example, the power source 104 of the master node device 101 may output the supply current 204 via the first wires 124, 126 contemporaneously as the first transmission signal 206 and the second transmission signal 208. The power source 104 may be configured to and/or define means for outputting a supply current via the two wires for at least the first slave node.

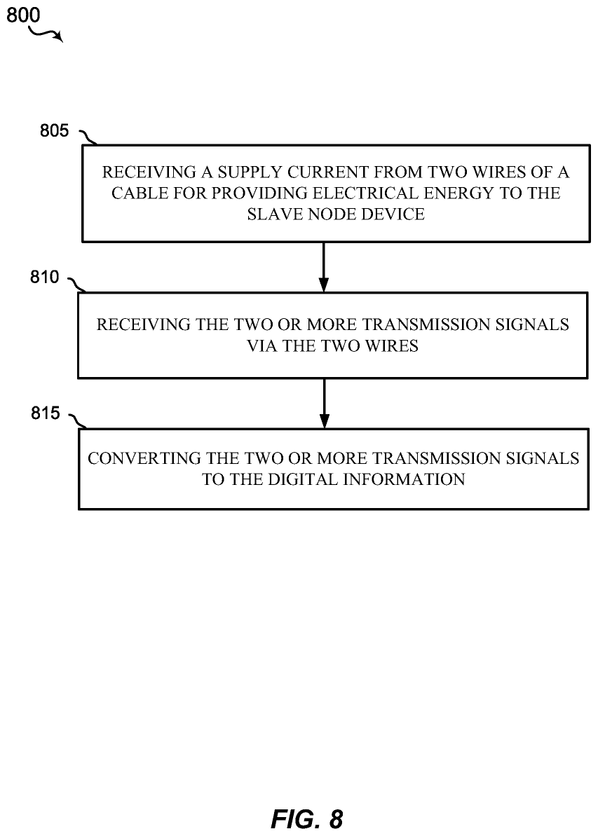

Turning to FIG. 8, an example of a method 800 for receiving digital information may be performed by at least one of the one or more slave nodes 160-1 . . . 160-n, and/or the subcomponents of the at least one of the one or more slave nodes 160-1 . . . 160-n.

At block 805, the method 800 may receive a supply current from two wires of a cable for providing electrical energy to the slave node device. For example, the processor 652 of the first slave node 160-1 may receive the supply current 204 from the first wires 124, 126 of the cable 122 for providing electrical energy to the first slave node device 161-1. The processor 652 may be configured to and/or define means for receiving a supply current from two wires of a cable for providing electrical energy to the slave node device.

At block 810, the method 800 may receive two or more transmission signals via the two wires. For example, the processor 652, the interface 656, and/or the communication circuit 662 of the first slave node 160-1 may receive the first received signal 306 and the second received signal 308. The processor 652, the interface 656, and/or the communication circuit 662 may be configured to and/or define means for receiving the two or more transmission signals via the two wires.

At block 815, the method 800 may convert the two or more transmission signals to digital information. For example, the processor 652 and/or the communication circuit 662 of the first slave node 160-1 may convert the first received signal 306 and the second received signal 308 to the first digital data 580 or the second digital data 581. The processor 652 and/or the communication circuit 662 may be configured to and/or define means for converting the two or more transmission signals to the digital information.

### Additional Aspects of the Present Disclosure

Aspects of the present disclosure include a circuit for digital communication, including: a cable having two wires and a shielding layer, wherein the shielding layer is connected to a common voltage terminal, a master node configured to: generate digital information, convert the digital information to two or more transmission signals, and output each of the two or more transmission signals onto a respective wire of the two wires, a power source configured to output a supply current via the two wires, and a first slave node configured to: receive the supply current from the two wires for providing electrical energy to the first slave node, receive the two or more transmission signals via the two wires, and convert the two or more transmission signals to the digital information.

Aspects of the present disclosure include the circuit above, further including at least a low pass filter configured to: receive the supply current from the power source, suppress at least a portion of alternating current (AC) energy in the supply current to generate a filtered supply current, and output the filtered supply current onto the two wires for the first slave node.

Aspects of the present disclosure include any of the circuits above, further including two or more high pass filters each configured to: receive a respective transmission signal of the two or more transmission signals, suppress at least a portion of direct current (DC) energy in the respective transmission signal to generate two or more filtered transmission signals, and output each of the two or more filtered transmission signals onto the respective wire of the two wires.

Aspects of the present disclosure include any of the circuits above, further including a switch configured to selectively provide a conductive path between the power source and the two wires.

Aspects of the present disclosure include any of the circuits above, further including a light emitting diode (LED) configured to illuminate in response to the switch being closed.

Aspects of the present disclosure include any of the circuits above, further including a current sensing circuit configured to detect an amount of the supply current, wherein the master node is further configured to transmit a control signal to the power source to adjust the supply current based on the amount.

Aspects of the present disclosure include any of the circuits above, further including a voltage sensing circuit configured to detect a voltage level of the supply current, wherein the master node is further configured to transmit a control signal to the power source to adjust the supply current based on the amount.

Aspects of the present disclosure include any of the circuits above, wherein the cable is a XLR cable.

Aspects of the present disclosure include any of the circuits above, further including a second slave node, wherein the first slave node is further configured to: generate second digital information based on at least portion of the digital information, convert the second digital information to two or more second transmission signals, output the two or more second transmission signals onto two second wires of a second cable for the second slave node.

Aspects of the present disclosure include any of the circuits above, further including at least a low pass filter configured to: receive the supply current from the power source, suppress at least a portion of alternating current (AC) energy in the supply current to generate a filtered supply current, and output the filtered supply current onto the two second wires for the second slave node.

Aspects of the present disclosure include methods and systems for transmitting digital information including generating digital information, converting the digital information to two or more transmission signals, outputting each of the two or more transmission signals onto a respective wire of two wires of a cable for at least a first slave node, and outputting a supply current via the two wires for at least the first slave node.

Aspects of the present disclosure include the methods and systems above, wherein outputting the supply current comprises: receiving the supply current from a power source of the master node device, suppressing at least a portion of alternating current (AC) energy in the supply current to generate a filtered supply current, and outputting the filtered supply current onto the two wires for at least the first slave node.

Aspects of the present disclosure include any of the methods and systems above, further including, prior to outputting each of the two or more transmission signals: suppressing at least a portion of direct current (DC) energy in the respective transmission signal of the two or more transmission signals.

Aspects of the present disclosure include any of the methods and systems above, further including selectively providing a conductive path between a power source of the master node device and the two wires via a switch.

Aspects of the present disclosure include any of the methods and systems above, further including illuminating a light emitting diode (LED) in response to the switch being closed.

Aspects of the present disclosure include any of the methods and systems above, further including: detecting an amount of the supply current, and transmitting a control signal to the power source to adjust the supply current based on the amount.

Aspects of the present disclosure include any of the methods and systems above, further including: detecting a voltage level of the supply current, and transmitting a control signal to the power source to adjust the supply current based on the amount.

Aspects of the present disclosure include methods and systems for receiving digital information including receiving a supply current from two wires of a cable for providing electrical energy to the slave node device, receiving two or more transmission signals via the two wires, and converting the two or more transmission signals to digital information.

Aspects of the present disclosure include the methods and systems above, further including generating second digital information based on at least portion of the digital information, converting the second digital information to two or more second transmission signals, and outputting the two or more second transmission signals onto two second wires of a second cable for a second slave node.

Aspects of the present disclosure include any of the methods and systems above, further including receiving the supply current from a power source, suppressing at least a portion of alternating current (AC) energy in the supply current to generate a filtered supply current, and outputting the filtered supply current onto the two second wires for the second slave node.

Aspects of the present disclosure include a master node device, comprising: a cable having two wires and a shielding layer, wherein the shielding layer is connected to a common voltage terminal, a master node comprising: a memory, a processor communicatively coupled to the memory and a communication circuit, the processor being configured to: generate digital information, transmit the digital information to the communication circuit, and the communication circuit configured to: convert the digital information to two or more transmission signals, and output each of the two or more transmission signals onto a respective wire of the two wires, and a power source configured to output a supply current via the two wires.

Aspects of the present disclosure include the master node device above, further comprising at least a low pass filter configured to: receive the supply current from the power source, suppress at least a portion of alternating current (AC) energy in the supply current to generate a filtered supply current, and output the filtered supply current onto the two wires for a slave node.

Aspects of the present disclosure include any of the master node devices above, further comprising two or more high pass filters each configured to: receive a respective transmission signal of the two or more transmission signals, suppress at least a portion of direct current (DC) energy in the respective transmission signal to generate two or more filtered transmission signals, and output each of the two or more filtered transmission signals onto the respective wire of the two wires.

Aspects of the present disclosure include any of the master node devices above, further comprising a switch configured to selectively provide a conductive path between the power source and the two wires.

Aspects of the present disclosure include any of the master node devices above, further comprising a light emitting diode (LED) configured to illuminate in response to the switch being closed.

Aspects of the present disclosure include any of the master node devices above, further comprising a current sensing circuit configured to detect an amount of the supply current, wherein the master node is further configured to transmit a control signal to the power source to adjust the supply current based on the amount.

Aspects of the present disclosure include any of the master node devices above, further comprising a voltage sensing circuit configured to detect a voltage level of the supply current, wherein the master node is further configured to transmit a control signal to the power source to adjust the supply current based on the amount.

Aspects of the present disclosure include a slave node device, comprising: a cable having two wires and a shielding layer, wherein the shielding layer is connected to a common voltage terminal, and a slave node comprising: a memory, a communication circuit configured to: receive two or more transmission signals via the two wires of the cable, convert the two or more transmission signals to digital information, transmit the digital information to a processor, and the processor communicatively coupled to the memory and the communication circuit, the processor being configured to: cause the slave node device to receive a supply current from the two wires for providing electrical energy to the slave node device, and receive the digital information.

Aspects of the present disclosure include the slave node device above, wherein: the processor is further configured to: generate second digital information based on at least portion of the digital information, and transmit the second digital information to the communication circuit, and the communication circuit is further configured to: receive the second digital information, convert the second digital information to two or more second transmission signals, output the two or more second transmission signals onto two second wires of a second cable for a second slave node.

Aspects of the present disclosure include any of the slave node devices above, further comprising at least a low pass filter configured to: receive the supply current from a power source, suppress at least a portion of alternating current (AC) energy in the supply current to generate a filtered supply current, and output the filtered supply current onto the two second wires for the second slave node.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

As described herein, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of digital communication by a master node device, comprising:
generating digital information;
converting the digital information to two or more transmission signals;
outputting each of the two or more transmission signals onto a respective wire of two wires of a cable for at least a first slave node; and
outputting a supply current via the two wires for at least the first slave node.

2. The method of claim 1, wherein outputting the supply current comprises:
receiving the supply current from a power source of the master node device;
suppressing at least a portion of alternating current (AC) energy in the supply current to generate a filtered supply current; and
outputting the filtered supply current onto the two wires for at least the first slave node.

3. The method of claim 2, further comprising, prior to outputting each of the two or more transmission signals:
suppressing at least a portion of direct current (DC) energy in the respective transmission signal of the two or more transmission signals.

4. The method of claim 1, further comprising selectively providing a conductive path between a power source of the master node device and the two wires via a switch.

5. The method of claim 4, further comprising illuminating a light emitting diode (LED) in response to the switch being closed.

6. The method of claim 1, further comprising:
detecting an amount of the supply current; and
transmitting a control signal to the power source to adjust the supply current based on the amount.

7. The method of claim 1, further comprising:
detecting a voltage level of the supply current; and
transmitting a control signal to the power source to adjust the supply current based on the amount.

8. A master node device, comprising:
a memory;
a processor communicatively coupled to the memory and a communication circuit, the processor being configured to:
generate digital information;
transmit the digital information to the communication circuit; and
the communication circuit coupled to a cable having two wires and a shielding layer, wherein the shielding layer is connected to a common voltage terminal, the communication circuit being configured to:
convert the digital information to two or more transmission signals; and
output each of the two or more transmission signals onto a respective wire of the two wires; and
a power source coupled to the cable and configured to output a supply current via the two wires.

9. The master node device of claim 8, further comprising at least a low pass filter configured to:
receive the supply current from the power source;
suppress at least a portion of alternating current (AC) energy in the supply current to generate a filtered supply current; and
output the filtered supply current onto the two wires for a slave node.

10. The master node device of claim 9, further comprising two or more high pass filters each configured to:
receive a respective transmission signal of the two or more transmission signals;
suppress at least a portion of direct current (DC) energy in the respective transmission signal to generate two or more filtered transmission signals; and
output each of the two or more filtered transmission signals onto the respective wire of the two wires.

11. The master node device of claim 8, further comprising a switch configured to selectively provide a conductive path between the power source and the two wires.

12. The master node device of claim 11, further comprising a light emitting diode (LED) configured to illuminate in response to the switch being closed.

13. The master node device of claim 8, further comprising a current sensing circuit configured to detect an amount of the supply current, wherein the master node device is further configured to transmit a control signal to the power source to adjust the supply current based on the amount.

14. The master node device of claim 8, further comprising a voltage sensing circuit configured to detect a voltage level of the supply current, wherein the master node device is further configured to transmit a control signal to the power source to adjust the supply current based on the amount.

15. A slave node device, comprising:
a memory;
a communication circuit coupled to a cable having two wires and a shielding layer, wherein the shielding layer is connected to a common voltage terminal, the communication circuit being configured to:
receive two or more transmission signals via the two wires of the cable;
convert the two or more transmission signals to digital information;
transmit the digital information to a processor; and
the processor communicatively coupled to the memory and the communication circuit, the processor being configured to:
cause the slave node device to receive a supply current from the two wires for providing electrical energy to the slave node device; and
receive the digital information.

16. The slave node device of claim 15, wherein:
the processor is further configured to:
generate second digital information based on at least portion of the digital information; and
transmit the second digital information to the communication circuit; and
the communication circuit is further configured to:
receive the second digital information;
convert the second digital information to two or more second transmission signals;
output the two or more second transmission signals onto two second wires of a second cable for a second slave node device.

17. The slave node device of claim 16, further comprising at least a low pass filter configured to:
receive the supply current from a power source;
suppress at least a portion of alternating current (AC) energy in the supply current to generate a filtered supply current; and
output the filtered supply current onto the two second wires for the second slave node device.
